(19) United States
(12) Patent Application Publication
(10) Pub. No.: US 2010/0087134 A1
(43) Pub. Date: Apr. 8, 2010

(54) VEHICLE HVAC SYSTEM

(75) Inventors: Gregory A. Major, Farmington Hills, MI (US); William R. Hill, Troy, MI (US)

Correspondence Address: MacMillan, Sobanski & Todd, LLC;One Maritime Plaza, 720 Water Street, 5th Floor, Toledo, OH, 43604, US

(73) Assignee: GM GLOBAL TECHNOLOGY OPERATIONS, INC., Detroit, MI (US)

(21) Appl. No.: 12/246,652

(22) Filed: Oct. 7, 2008

(51) Int. Cl. B60H 1/24

(52) U.S. Cl. 454/162

(57) ABSTRACT

An HVAC system for a vehicle is disclosed. The HVAC system may comprise an HVAC module configured to selectively direct conditioned air through an HVAC outlet; and an HVAC air distribution system including a duct operatively engaging the HVAC outlet to receive air flow therefrom, a top outlet configured to be positioned above an instrument panel, a heater outlet configured to be located below the instrument panel, and a diverter located in the duct and configured to selectively direct the air flow from the HVAC outlet through the duct to the top outlet and the heater outlet.

### BACKGROUND OF INVENTION

The present invention relates generally to a heating, ventilation and air conditioning (HVAC) system for a vehicle.

Typical automotive vehicles include an HVAC system having an HVAC module that connects to cross car ducts, which distribute the air through defrost ducts, instrument panel outlets and floor outlets (heating outlets). The HVAC modules have air distribution controls in the modules themselves, which control the ducts to which the air is directed. This design, while convenient for passengers and lending itself to automation, adds to the size, complexity and cost of the HVAC system. For some automotive vehicles manufactured for emerging markets, costs must be minimized to make the vehicles affordable, and space for packaging vehicle components is at a premium. Thus, the conventional HVAC module and duct work may be undesirable for these types of vehicles.

### SUMMARY OF INVENTION

An embodiment contemplates an HVAC system for a vehicle that may comprise an HVAC module and an HVAC air distribution system. The HVAC module may be configured to selectively direct conditioned air through an HVAC outlet. The HVAC air distribution system may include a duct operatively engaging the HVAC outlet to receive air flow therefrom, a top outlet configured to be positioned above an instrument panel, a heater outlet configured to be located below the instrument panel, and a diverter located in the duct and configured to selectively direct air flow from the HVAC outlet through the duct to the top outlet and the heater outlet.

An advantage of an embodiment is that the HVAC air distribution system eliminates the need for a mode door and actuators in an HVAC module, which may allow for a reduced size and cost of the HVAC module. The overall cost of the HVAC system may be reduced while still maintaining a high degree of functionality.

### BRIEF DESCRIPTION OF DRAWINGS

FIG. 1 is a schematic view of a portion of a vehicle and an HVAC system.

FIG. 2 is a view of a portion of a vehicle and an HVAC system according to a second embodiment.

FIG. 3 is a view of a portion of a vehicle and an HVAC system according to a third embodiment.

FIG. 4 is a view of a portion of a vehicle and an HVAC system according to a fourth embodiment.

### DETAILED DESCRIPTION

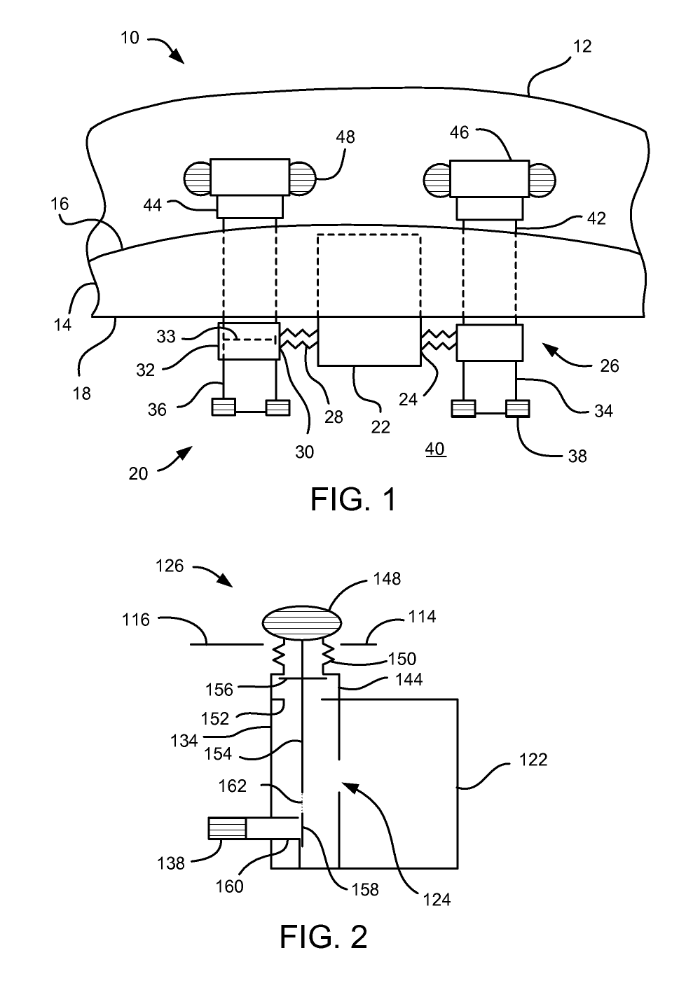

Referring to FIG. 1, a portion of a vehicle, indicated generally at 10, is shown. The vehicle 10 includes a windshield 12 with an instrument panel 14 adjacent to it. Mounted within, extending above a top 16 of the instrument panel 14, and extending below a bottom 18 of the instrument panel 14, is a portion of an HVAC system 20.

The HVAC system 20 includes an HVAC module 22. Air is drawn into the HVAC module 22, conditioned, and then directed through outlets 24 to an HVAC air distribution system 26. The HVAC air distribution system 26 includes flexible ducts 28 extending from the outlets 24 to inlets 30 of hand operable slide diverters 32. The slide diverters 32 are mounted on fixed ducts 34 and are configured to slide up and down on the ducts 34. Diversion plates 33 (only one shown) are mounted horizontally in the ducts 34 in the vicinity of the slide diverters 32. Sliding the slide diverts 32 up and down on the ducts 34 selectively directs air up or down in the ducts 34. Air directed downward through lower portions 36 of the ducts 34 is directed to heater outlets 38 (also called floor outlets) adjacent to a floor 40 of the vehicle 10. Upper portions 42 of the ducts 34 extend from the instrument panel 14 and connect to rotating ducts 44, which in turn connect to swivel ducts 46, which then connect to top outlets 48.

The operation of the HVAC system 20 will now be discussed. Upon activation of the HVAC system 20, the HVAC module 22 will draw in air, condition it, and blow it out through the outlets 24. The fan speed may be set in a conventional fashion. If the driver wishes to have air flow from the heater outlets 38, the driver will adjust the slide diverter 32 on the driver side of the vehicle 10 by hand to the position that will direct airflow down through the lower portion 36 and out through the heater outlets 38 near the vehicle floor 40. The passenger can do likewise on the passenger side of the HVAC air distribution system 26. As the particular slide diverter 32 is moved up or down to redirect airflow, the corresponding flexible duct 28 will bend to assure an airflow connection between the HVAC module 22 and the slide diverter 32.

Moving the slide diverters 32 in the other direction will direct the airflow up through the upper portions 42 and out through the top outlets 48. The rotating ducts 44 allow the top outlets 48 to be pivoted by hand about a vertical axis in order to aim the airflow in a desired right/left direction. Likewise the swivel ducts 46 can be pivoted by hand about a generally horizontal axis in order to aim the air flow from the top outlets 48 in a desired up/down direction. The rotating ducts 44 may allow for rotation all the way around such that the top outlets 48 face the windshield 12, thus creating a defrost mode for the windshield 12. Alternatively, separate ducts may be run in a more conventional fashion to allow for directing air directly onto the windshield.

One will note that this HVAC system 20 removes an air management function from the HVAC module and incorporates it into the ducts of the HVAC air distribution system 26. Also, all air distribution adjustments can be accomplished manually by occupants of the vehicle. This is accomplished while still allowing for independent motor control for right and left vehicle occupants.

FIG. 2 illustrates a second embodiment. Since this embodiment is similar to the first, similar element numbers will be used for similar elements, but employing 100-series numbers. In this embodiment, only one of two sides of the HVAC air distribution system 126 is shown. Of course, both driver and passenger side air distribution can be employed, as is shown in FIG. 1.

A rotating duct 144 mounts over an upper outlet 152 in a duct 134 that is in fluid communication with an outlet 124 of the HVAC module 122. An extendable duct section 150 mounts on top of the rotating duct 144 and supports a top outlet 148. The top outlet 148 can be moved up and down by hand to pull the top outlet out of the top 116 of the instrument panel 114 or push it down into the instrument panel 114. Preferably, the extendable duct section 150 provides enough stiffness to support the top outlet 148 in the position it has been moved to buy the vehicle occupant. The rotating duct 144 allows the top outlet 148 to be rotated about a vertical axis to aim the top outlet 148 in a desired airflow direction. Optionally, a swivel feature may also be included in the second embodiment similar to that incorporated into the first embodiment. Also, the top of the top outlet 148 may be shaped to be flush with the top 116 of the instrument panel 114 when the top outlet 148 is in its retracted position.

A diverter rod 154 connects to and moves up and down with the top outlet 148. A top outlet valve 156 is mounted to and moves up and down with the diverter rod 154. The top outlet valve 156 is located on the diverter rod 154 such that when the top outlet 148 is moved down to its retracted position, the top outlet valve 156 will essentially close the upper outlet 152.

The diverter rod 154 also includes a heater outlet valve 158 that slides up and down adjacent to a heater flow channel 160. The heater flow channel 160 directs air flow to a heater outlet 138. The heater outlet valve 158 includes a flow opening 162 (indicated by a dotted line in FIG. 2) that aligns with the heater flow channel 160 when the top outlet 148 is pushed down into its retracted position. On the other hand, the heater outlet valve 158 blocks flow through the heater flow channel 160 when the top outlet 148 is lifted up to its operating position since the flow opening 162 is no longer aligned with the heater flow channel 160.

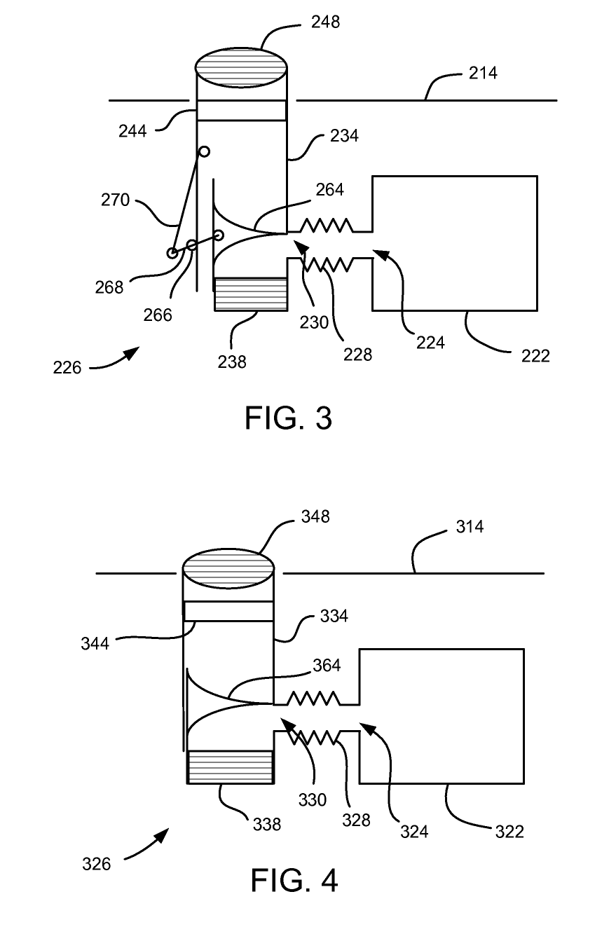

FIG. 3 illustrates a third embodiment. Since this embodiment is similar to the first, similar element numbers will be used for similar elements, but employing 200-series numbers. In this embodiment, only one of two sides of the HVAC air distribution system 226 is shown. Of course, both driver and passenger side air distribution can be employed, as is shown in FIG. 1.

The HVAC module 222 has an outlet 224 directing air flow to a flexible duct 228, which, in turn, directs the air to an inlet 230 of a fixed duct 234. A movable flow diverter 264 is mounted in the fixed duct 234 and is connected to a diverter cam 266 via a rod 268, with a handle 270 also engaging the rod 268. The handle 270 can be moved by hand to cause the flow diverter 264 to slide up and down in the fixed duct 234. When the flow diverter 264 is slid to its top position (as shown in FIG. 3), air flow is directed down through a heater outlet 238. When the flow diverter 264 is slid to its bottom position, air flow is directed up through the top outlet 248 above the instrument panel 214. The fixed duct 234 may include a rotating duct portion 244, and may also include a swivel duct portion (not shown in this embodiment) similar to that shown in FIG. 1.

FIG. 4 illustrates a fourth embodiment. Since this embodiment is similar to the first, similar element numbers will be used for similar elements, but employing 300-series numbers. In this embodiment, only one of two sides of the HVAC air distribution system 326 is shown. Of course, both driver and passenger side air distribution can be employed, as is shown in FIG. 1.

The HVAC module 322 has an outlet 324 directing air flow to a flexible duct 328, which, in turn, directs the air to an inlet 330 of a movable duct 334. A fixed flow diverter 364 is mounted in the movable duct 334. When one pulls the top outlet 348 up and down, the movable duct 334 will slide up and down with it. The movable duct 334, then, will slide up and down relative to the flow diverter 364. When one pushes the top outlet 348 down into the instrument panel 314, the inlet 330 is slid down relative to the flow diverter 364 (as shown in FIG. 4), so that air flow is directed down through a heater outlet 338. When the top outlet 348 is pulled upward, the inlet 330 moves upward to a second position relative to the flow diverter 364, where air flow is directed up through the top outlet 348 above the instrument panel 314. The movable duct 334 may include a rotating duct portion 344, and may also include a swivel duct portion (not shown in this embodiment) similar to that shown in FIG. 1. Alternatively, the movable duct 334 may include a built-in swiveling and rotating function by having a semi-rigid portion under the top outlet 348 that allows for some twisting and bending in the duct itself while still being stiff enough the support the top outlet 348. This semi-rigid portion may be similar to the extendible duct section 150 in the embodiment of FIG. 2.

While certain embodiments of the present invention have been described in detail, those familiar with the art to which this invention relates will recognize various alternative designs and embodiments for practicing the invention as defined by the following claims.

What is claimed is:

1. An HVAC system for a vehicle comprising:
an HVAC module configured to selectively direct conditioned air through an HVAC outlet; and
an HVAC air distribution system including a duct operatively engaging the HVAC outlet to receive air flow therefrom, a top outlet configured to be positioned above an instrument panel, a heater outlet configured to be located below the instrument panel, and a diverter located in the duct and configured to selectively direct the air flow from the HVAC outlet through the duct to the top outlet and the heater outlet.

2. The HVAC system of claim 1 wherein the duct includes a rotating duct portion mounted below the top outlet and configured to allow for rotation of the top outlet about a vertical axis.

3. The HVAC system of claim 1 wherein the duct includes a swivel duct portion configured to allow for rotation of the top outlet about a horizontal axis.

4. The HVAC system of claim 1 including a flexible duct connecting the HVAC outlet to an inlet to the duct, wherein the duct and the inlet to the duct are configured to move with the top outlet, and wherein the top outlet is movable into and out of the instrument panel such that movement of the top outlet out of the instrument panel will move the inlet relative to the diverter to cause the air flow to be directed through the top outlet and movement of the top outlet into the instrument panel will move the inlet relative to the diverter to cause the air flow to be directed through the heater outlet.

5. The HVAC system of claim 1 including an air flow duct connecting the HVAC outlet to an inlet to the duct, and wherein the diverter includes a movable diverter member located adjacent to the inlet and a hand movable member configured to move the movable diverter member between a first position directing the air flow from the inlet to the top outlet and a second position directing the air flow from the inlet to the heater outlet.

6. The HVAC system of claim 5 wherein the hand movable member includes a diverter rod connecting the movable diverter to a diverter handle via a cam, whereby movement of the diverter handle will cause the movable diverter to move relative to the inlet.

7. The HVAC system of claim 1 including a flexible duct connecting to the HVAC outlet, and wherein the diverter includes a slide diverter slidable up and down on the duct and having an inlet engaging the flexible duct, and a diversion plate extending horizontally across the duct adjacent to the inlet such that sliding of the slide diverter upwards on the duct will direct the air flow above the diversion plate toward the top outlet and sliding of the slide diverter downwards on the duct will direct the air flow below the diversion plate toward the heater outlet.

8. The HVAC system of claim 1 wherein the diverter includes a diverter rod supported by and movable with the top outlet, a top outlet valve configured to allow the air flow into the top outlet when the top outlet is raised to an extended position, and a flow opening in the diverter rod that is configured to permit the air flow to the heater outlet when the top outlet is lowered to a retracted position.

9. The HVAC system of claim 8 wherein the HVAC air distribution system includes an extendable duct extending upward from the duct, with the top outlet mounted on and supported by the extendable duct.

10. The HVAC system of claim 1 wherein the HVAC module includes a second HVAC outlet and the HVAC air distribution system includes a second duct operatively engaging the second HVAC outlet to receive the air flow therefrom, a second top outlet configured to be positioned above the instrument panel, a second heater outlet configured to be located below the instrument panel, a second diverter located in the second duct and configured to selectively direct the air flow from the second HVAC outlet through the second duct to the second top outlet and the second heater outlet.

11. The HVAC system of claim 10 wherein the duct includes a rotating duct portion mounted below the top outlet and configured to allow for rotation of the top outlet about a vertical axis and the second duct includes a second rotating duct portion mounted below the second top outlet and configured to allow for rotation of the second top outlet about a second vertical axis.

12. The HVAC system of claim 11 wherein the rotation duct portion and the second rotation duct portion are configured to allow the top outlet and the second top outlet, respectively, to face and direct the air flow onto a windshield.

13. The HVAC system of claim 12 wherein the duct includes a swivel duct portion configured to allow for rotation of the top outlet about a horizontal axis and the second duct includes a second swivel duct portion configured to allow for rotation of the second top outlet about a second horizontal axis.

14. The HVAC system of claim 11 wherein the duct includes a swivel duct portion configured to allow for rotation of the top outlet about a horizontal axis and the second duct includes a second swivel duct portion configured to allow for rotation of the second top outlet about a second horizontal axis.

15. The HVAC system of claim 10 wherein the duct includes a swivel duct portion configured to allow for rotation of the top outlet about a horizontal axis and the second duct includes a second swivel duct portion configured to allow for rotation of the second top outlet about a second horizontal axis.
